(19) United States
(12) Patent Application Publication
(10) Pub. No.: US 2007/0097152 A1
(43) Pub. Date: May 3, 2007

(54) Display device driving circuit

(75) Inventors: Shuji Hagino, Kobe-shi (JP); Martin Rudolf Herrmann, Hedingen (CH); Marko Radovic, Wildberg (DE); Eckart Rzittka, Wildberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,131

(22) PCT Filed: Dec. 6, 2004
(86) PCT No.: PCT/IB04/52662

§ 371 Date: Jun. 1, 2006

(30) Foreign Application Priority Data
Dec. 8, 2003 (WO) PCT/IB03/05846

(51) Int. Cl. G09G 5/10

(52) U.S. Cl. 345/690

(57) ABSTRACT

The present invention provides a driving circuit capable of reducing power consumption in an amplifier for outputting a target voltage. A driving circuit for driving a capacitive load Ccol of a display device, comprising: driving signal supplying means (10) for supplying a driving signal Vin having a target voltage to be applied; an amplifying stage (20) for receiving the driving signal Vin and selectively outputting the driving signal Vin to the capacitive load Ccol; and a pair of current sources Ipcp, Ipcn for selectively supplying a positive current and a negative current to the capacitive load Ccol, respectively during their on-states. The driving circuit repeats a repetitive operation including a pre-operation where any one of the current sources Ipcp, Ipcn is switched ON in accordance with the driving signal Vin and then switched OFF and a post-operation where the amplifying stage (20) is switched to a state for outputting the driving signal Vin to the capacitive load Ccol after the pre-operation.

### TECHNICAL FIELD

The present invention widely relates to a driving circuit of a display device. Particularly, the present invention relates to a driving circuit for supplying a target voltage signal to a capacitive load in a display device, and more specifically, to a display driving circuit for applying voltages corresponding to pixel information signals to column electrodes of a display device such as a liquid crystal display panel.

### BACKGROUND ART

Patent Document 1 describes such a type of driving circuit. This driving circuit is arranged to switch on a pre-charge switching element in a buffer amplification section in advance at the time the common voltage is inverted on a horizontal period basis so as to pre-charge an output terminal to a power supply potential or ground potential, and then the potential is made decreased or increased to the intermediate potential by operating a selection switching element. In this way, since the output voltage is pulled to the intermediate potential after being pre-charged to the power supply potential or ground potential, it is possible to faster apply the desired voltage to a liquid crystal capacitance when a target voltage is near the intermediate potential.

However, in the driving circuit in Document 1, since the output terminal connected to the load is once pulled to the intermediate potential and then stabilized at the target voltage, the output voltage varies from the intermediate potential to the target voltage level, which may cause a loss in driving the load unless the target voltage level is exactly equal to the intermediate potential. Therefore, an amplifier for outputting the target voltage may consume unnecessary power. Such consumption becomes a more significant problem especially in an apparatus that may use target voltage levels considerably different from the intermediate potential, i.e., in a system that operates in a wider dynamic range.

[Patent Document 1]

Japanese Patent Application Laid-Open No. 122733/96 (see specifically, paragraphs to [0057], [0065], [0066] and [0074])

### DISCLOSURE

(Object)

In view of the foregoing, it is an object of the present invention to provide a driving circuit that can reduce power consumption of an amplifier for outputting a target voltage.

It is another object of the present invention to provide a driving circuit capable of contributing to power savings.

(Constitution)

In order to achieve the above objects, a driving circuit according to a first aspect of the present invention is a driving circuit for driving a capacitive load of a display device, comprising: driving signal supplying means for supplying a driving signal having a target voltage to be applied; an amplifying stage for receiving the driving signal and selectively outputting the driving signal to the capacitive load; and a pair of current sources for selectively supplying a positive current and a negative current to the capacitive load, respectively during their on-states, the driving circuit repeating a repetitive operation including a pre-operation where any one of the current sources is switched ON in accordance with the driving signal and then switched OFF and a post-operation where the amplifying stage is switched to a state for outputting the driving signal to the capacitive load after the pre-operation.

In this way, since the capacitive load is charged and discharged by the current sources, the output voltage gradually changes to the target voltage, whereby it is possible to suppress the driving loss for the load.

In this aspect, a duration length of an ON period of the relevant current source and/or a current supply rate of the relevant current source during the pre-operation may be made variable in accordance with a value of the driving signal in a repetition period of the repetitive operation. It is thereby possible to make the output substantially equal to the target voltage based on a predetermine reference voltage after the pre-operation is finished, the amplifying stage is thus only required to operate to output the subsequent stable voltage, and it is thereby possible to suppress the useless power consumption in the amplifying stage as much as possible.

Further, a duration length of an ON period of the relevant current source and/or a current supply rate of the relevant current source during the pre-operation may be made variable in accordance with a value of the driving signal in a repetition period of the repetitive operation and a value of the driving signal in another repetition period previous to said repetition period. In this way, without using the reference voltage, it is possible to make the output substantially equal to the target voltage after finishing the pre-operation.

Alternatively, a driving circuit according to the other aspect of the invention is a driving circuit for driving a capacitive load of a display device, comprising: driving signal supplying means for supplying a driving signal having a target voltage to be applied; an amplifying stage for receiving the driving signal and selectively outputting the driving signal to the capacitive load; a pair of power sources for selectively performing charging and discharging to the capacitive load, respectively; and comparing means having one input receiving a voltage value of the driving signal and the other input receiving a voltage value on an output line coupled to the capacitive load, the driving circuit repeating a repetitive operation including a pre-operation where charging or discharging is performed by any one of the power sources and then stopped and a post-operation where the amplifying stage is switched to a state for outputting the driving signal to the capacitive load after the pre-operation, the charging and discharging operation performed by the pair of the power sources being controlled based on a comparison output of the comparing means during the pre-operation.

By doing so, it is possible to achieve an appropriate charging/discharging control adapted to a value of the driving signal in the pre-operation every time the value of the driving signal is updated.

This aspect may take the following manner: a discharging operation is performed if the comparison output indicates that the voltage value on the output line is greater than the voltage value of the driving signal, an a charging operation is performed if the comparison output indicates that the voltage value on the output line is smaller than the voltage value of the driving signal; and in addition, one of the charging and discharging operations is continued until the comparison output indicates that the voltage value on the output line reaches the voltage value of the driving signal.

In the above aspects and their embodied forms, the target voltage may be a gray-scale voltage, the capacitive load may be a liquid crystal cell, and/or the driving signal supplying means may include analog to digital converting means. It is thus possible to take full advantages described above in a display device.

The present invention also provides a display device making use of features of the driving circuit described above.

It should be noted that the amplifying stage is only required to take a form of outputting the driving signal selectively, and therefore it should be understood that the stage includes a form without having an amplifier, as described below.

### DESCRIPTION OF DRAWINGS

FIG. 1 is a block diagram illustrating a schematic configuration of a driving circuit according to a first embodiment of the present invention;

FIG. 2 is a time chart illustrating the operation in the driving circuit as illustrated in FIG. 1;

FIG. 3 is a block diagram illustrating a schematic configuration of a driving circuit according to a second embodiment of the present invention;

FIG. 4 is a time chart illustrating the operation in the driving circuit as illustrated in FIG. 3;

FIG. 5 is a block diagram illustrating a schematic configuration of a driving circuit of a modification complying with the present invention;

FIG. 6 is a block diagram illustrating a configuration upstream from the driving circuit, which includes a control signal generating circuit applied to each embodiment;

FIG. 7 is a table showing a data storage state in a look-up table memory in the control signal generating circuit;

FIG. 8 is a conceptual view showing a relationship between grayscale levels and driving voltage levels;

FIG. 9 is a block diagram illustrating a schematic configuration of a driving circuit according to a third embodiment 3 of the present invention;

FIG. 10 is a time chart illustrating the operation in the driving circuit as illustrated in FIG. 9;

FIG. 11 is a block diagram illustrating a schematic configuration of a driving circuit according to one modification of the present invention;

FIG. 12 is a time chart illustrating the operation in the driving circuit as illustrated in FIG. 11; and

FIG. 13 is a block diagram illustrating a schematic configuration of a driving circuit according to another modification of the present invention.

### BEST MODE

Embodied forms of the present invention will now be described in more detail below with reference to accompanying drawings by way of embodiments.

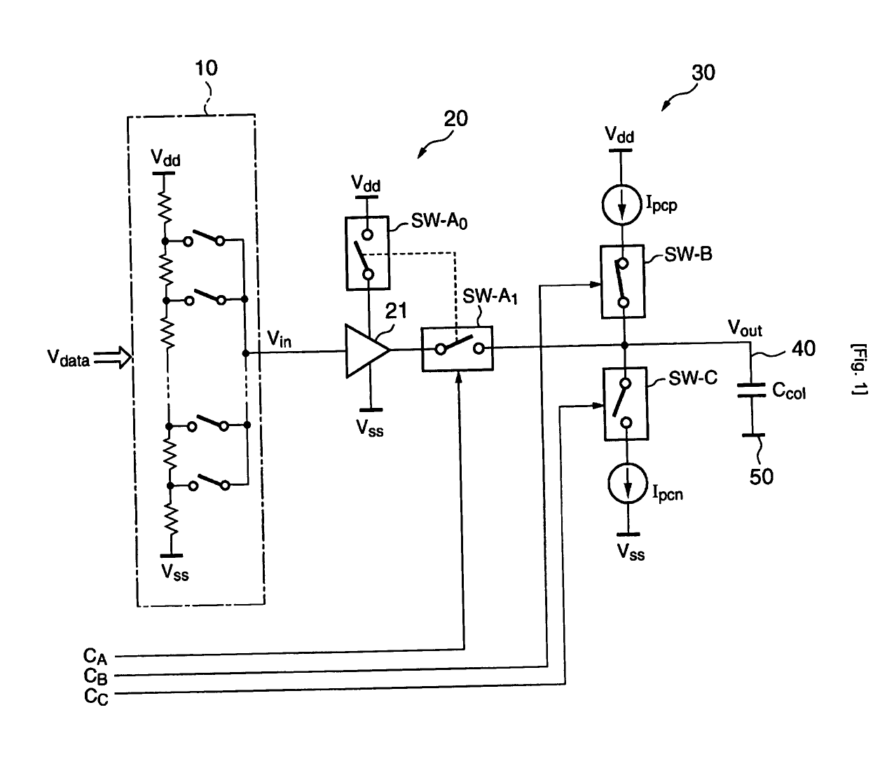

FIG. 1 illustrates a schematic configuration of a driving circuit according to a first embodiment of the present invention.

The driving circuit is to drive a capacitive load of a display device, and in this embodiment, is a driving circuit for supplying a pixel information signal to each column electrode of a passive or active matrix type liquid crystal display panel.

The driving circuit has at its first stage a gray-scale voltage generating circuit 10 which serves as driving signal supplying means for supplying a driving signal with the target voltage to be applied, the generating circuit 10 having a function of digital to analog conversion. The gray-scale voltage generating circuit 10 has a voltage dividing circuit formed of a plurality of resistance elements connected in series to each other. As shown in FIG. 1, the voltage dividing circuit 10 is coupled at its one end to a positive power supply voltage Vdd, while being coupled at the other end to a negative power supply voltage Vss. The voltage dividing circuit 10 divides a voltage between Vdd and Vss, and generates a plurality of gray-scale voltages that have stepwise increasing or decreasing gradient. Common connection points of the resistance elements are connected to one ends of switching elements, respectively. The other ends of the switching elements are all commonly connected and led out as an output end of the gray-scale voltage generating circuit 10. The switching elements can individually be controlled, and any one of the switching elements is switched ON in accordance with an input pixel information signal Vdata. In this way, only a switching element having been switched ON relays a gray-scale voltage corresponding to a gray-scale level indicated by the pixel information signal Vdata among various gray-scale voltages made in the dividing circuit, and a driving signal Vin with the relayed gray-scale voltage is outputted.

The driving circuit further has an amplifying stage 20 that receives the driving signal Vin. The amplifying stage 20 has an amplifier 21 with signal input and output terminals and positive and negative power supply terminals, and a pair of switching elements SW-A₀ and SW-A₁ coupled to the positive power supply terminal and signal output terminal of the amplifier 21, respectively. One of the switching elements, SW-A₀, is connected at one end to the positive power supply terminal of the amplifier 21, while being connected at the other end to the positive power supply voltage Vdd. The other one of the switching elements, SW-A₁, is connected at one end to the signal output terminal of the amplifier 21, while being connected at the other end to an output line 40. The pair of switches SW-A₀ and SW-A₁ are synchronized with each other in ON/OFF operation, and are ON or OFF simultaneously in response to a common control signal C_{A}. When the pair of switches SW-A₀ and SW-A₁ are ON, the driving signal Vin from the gray-scale voltage generating circuit 10 is outputted to the output line 40 via the activated amplifier 21. When the pair of switches SW-A₀ and SW-A₁ are OFF, the amplifier 21 is not powered by the supply and are isolated from the output line 40, so that the amplifier 21 does not involve power consumption. It is noted that the embodiment is intended to use a configuration based on a pair of switches, i.e., two switches, SW-A₀ and SW-A₁ as means for controlling the driving signal Vin about whether or not to relay to the output line 40. However, such means may be arranged to use a configuration with only one switch, SW-A₀, which controls the power supply to the amplifier 21.

The driving circuit further has an output stage 30 downstream from the amplifying stage 20. The output stage 30 has, as basic structural elements, a current source Ipcp (preferably, stabilized) which is coupled to the positive power supply voltage Vdd and generates a current with a positive polarity (current that flows into the output line 40), and a current source Ipcn (preferably, stabilized) which is coupled to the negative power supply voltage Vss and generates a current with a negative polarity (current that flows from the output line 40). The output stage 30 further has switches SW-B and SW-C that are connected between the current source Ipcp and the output line 40, and between the current source Ipcn and the output line 40, respectively. The switches SW-B and SW-C are to control conduction/out-of-conduction between the current source Ipcp, Ipcn and the output line 40, and are capable of being individually controlled to ON or OFF separately in accordance with a control signal C_{B}, C_{C}. When the switch SW-B is ON, the current with the positive polarity from the current source Ipcp is supplied to the output line 40 via the switch SW-B. When the switch SW-C is ON, the current with the negative polarity from the current source Ipcn is supplied to the output line 40 via the switch SW-C. It is noted that in this embodiment only one of the switches SW-B and SW-C is allowed to be switched ON, and it is not allowed to carry out a control to simultaneously switch both of them.

In this Embodiment, the output line 40 is connected to a column electrode extending longitudinally in a liquid crystal display panel. The column electrode is to specify one potential to determine an optical state of a pixel of the liquid crystal medium in the liquid crystal display panel, and applies the voltage locally to the liquid crystal medium in cooperation with, for example, a so-called common electrode 50 that specifies another potential. In this case, the column electrode and liquid crystal medium can be regarded as an equivalent capacitance Ccol sandwiched between the output line 40 and the common electrode 50. The driving circuit supplies the driving signal to the equivalent capacitance Ccol as a capacitive load. It is noted that this Embodiment may cover a configuration where an active element such as a TFT (Thin Film Transistor) is provided for each pixel and the one potential is given via the active element to the pixel in accordance with a driving signal supplied to the column electrode, and may cover a configuration where the common electrode 50 is replaced with row electrodes extending longitudinally and crossing the column electrodes.

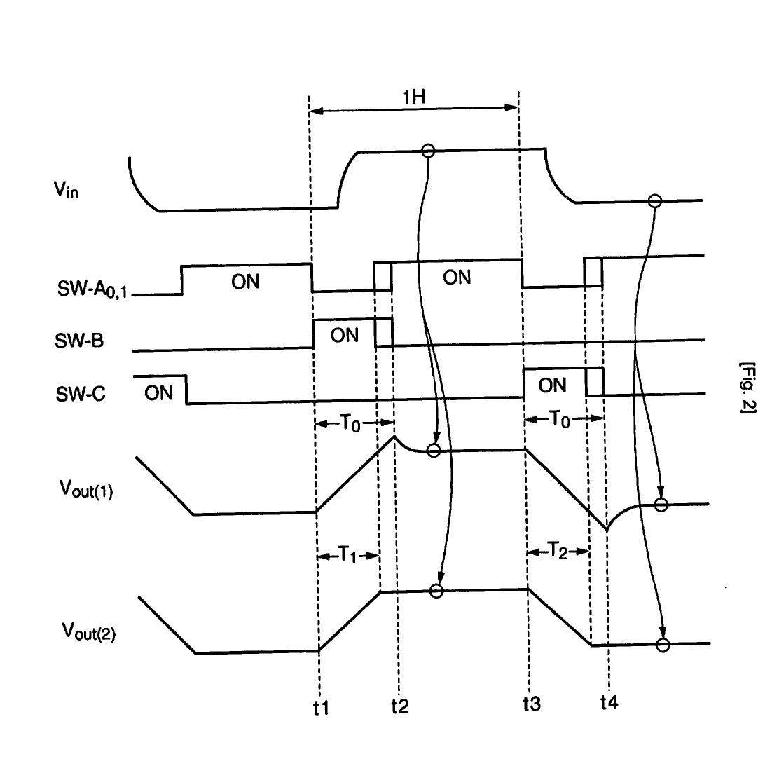

The operation of the driving circuit will be described below with reference to the time chart in FIG. 2.

In a horizontal scanning period (1H) that is an update period of the driving signal Vin that carries a gray-scale voltage, the driving circuit performs a basic operation including a pre-operation in the output stage 30 based on the current sources and a post-operation where the amplifying stage 20 ultimately stabilizes the output line 40 at a potential of the driving signal Vin after the pre-operation.

More specifically, in a horizontal scanning period, only the switch SW-B is first switched ON in the output stage 30 (t1). An output current of the current source Ipcp thereby flows to the output line 40, the equivalent capacitance Ccol is charged with the current and the voltage between the opposite ends increases gradually (see t1-t2 in Vout (1)).

After a predetermined time period T₀ has elapsed (t2), the switch SW-B is switched OFF, and then, switches SW-A₀ and SW-A₁ are switched ON. Accordingly, the charging of the equivalent capacitance Ccol due to the current source Ipcp is stopped while an output of the amplifier 21 is supplied to the output line 40. Therefore, in the horizontal scanning period, the amplifier 21 relays to the output line 40 the driving signal Vin having a target gray-scale voltage designated by the pixel information signal Vdata, and the output line 40 converges to the driving signal level (see t2-t3 in Vout (1)).

Also in the next horizontal scanning period, a series of operation is carried out including the operation of the switches in the output stage 30 and the operation of the amplifying stage 20. However, after the driving with a positive polarity is carried out as in the period of t1 to t3, the driving is carried out in a negative polarity. Therefore, in this horizontal scanning period, only the switch SW-C is switched ON (t3), the current is pulled from the output line 40 into the current source Ipcn, the equivalent capacitance Ccol is discharged with the current, and the voltage between the opposite ends decreases gradually (see t3-t4 in Vout(1)). Then, after the predetermined time period T₀ has elapsed likewise (t4), the switch SW-C is switched OFF, and the switches SW-A₀ and SW-A₁ are switched ON. Accordingly, the discharging of the equivalent capacitance Ccol due to the current source Ipcn is stopped while an output of the amplifier 21 is supplied to the output line 40. Therefore, in the horizontal scanning period, the amplifier 21 relays to the output line 40 the driving signal Vin having a target gray-scale voltage designated by the pixel information signal Vdata, and the output line 40 converges to the driving signal level (see t4—in Vout (1)).

Thus, the driving circuit repeats the repetitive operation, while alternating the driving polarities every horizontal scanning period, including the pre-operation (pre-charge period) where only any one of the current sources Ipcp and Ipcn is switched ON in accordance with the driving signal Vin and then switched OFF, and the post-operation where the amplifying stage 20 is switched to a state for outputting the driving signal Vin to the equivalent capacitance Ccol as the capacitive load after the pre-operation is carried out.

According to the driving circuit with the configuration and operation as described above, it is possible to provide the advantageous effects specific to the present invention. In other words, since the equivalent capacitance Ccol is charged and discharged using the current sources Ipcp and Ipcn in the output stage 30, the voltage of the output line 40 approaches the target voltage gradually and changes in voltage are thus smoother than those in the case of using voltage sources, so it is possible to suppress the driving loss of the equivalent capacitance.

The advantageous effects become further remarkable by setting lengths of ON periods (pre-charge periods) for activating the current sources Ipcp and Ipcn in the output stage 30 not to be constant (T₀) but to be variable, and altering the lengths of the periods in accordance with the input signal Vdata or driving signal Vin. FIG. 2 shows the example of this case in ‘Vout (2)’. In the output voltage Vout (2), the pre-charge periods of the current sources Ipcp and Ipcn are set to time periods T₁ and T₂ according to the driving signal Vin in the horizontal scanning period (i.e., time periods required for charging/discharging up to the target voltage), and the switches SW-A₀, SW-A₀, SW-B and SW-C are controlled in correspondence with the periods T₁ and T₂, whereby the voltage varies without useless transitions as compared to the case where the periods are set to the constant time period (T₀). In this way, it is possible to suppress the loss in driving the equivalent capacitance as much as possible and to limit the power consumption in the amplifier 21 to a required minimum level.

Although the embodiment adopts a so-called alternating-current driving system, wherein the target voltage with the positive polarity and the target voltage with a negative polarity with respect to the reference potential applied to the common electrode 50 are outputted in alternation on a horizontal scanning period basis, the present invention is not confined to such an alternating-current driving form. When the target voltage expressed by the driving signal Vin in a current horizontal scanning period is higher than the target voltage expressed by the driving signal Vin in the previous horizontal scanning period, the switch SW-B may be switched ON in the current horizontal scanning period to use the current source Ipcp enabling the charging. On the other hand, when the former is lower than the latter, the switch SW-C may be switched ON in the current horizontal scanning period to use the current source Ipcn enabling the discharging. In such modified form, it is possible to appropriately output a target voltage with the same polarity over the successive horizontal scanning periods. The same modification is capable of being carried out in embodiments described below.

Although the above embodiment is based on the control of lengths of the pre-charge time periods of current sources Ipcp and Ipcn, there may be a case of controlling current supply capabilities of the current sources Ipcp and Ipcn, i.e., the pre-charge rate or current supply rate as follows.

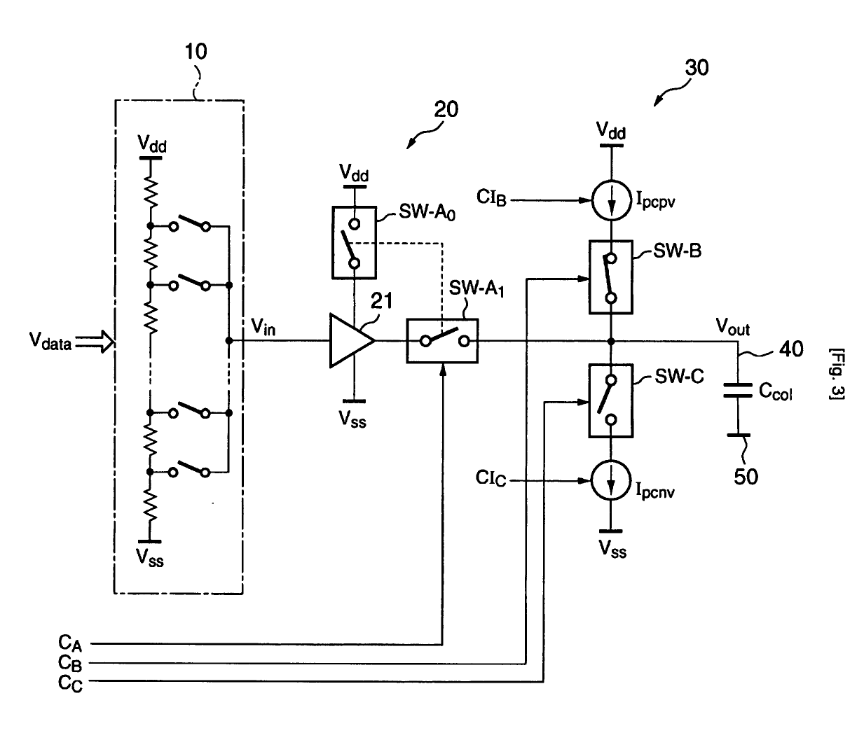

FIG. 3 illustrates a variable current supply rate type driving circuit, where variable rate type of power sources Ipcpv and Ipcnv are adopted, instead of the constant rate type of current sources Ipcp and Ipcn, and control signals CI_{B} and CI_{C} are inputted to the current sources Ipcpv and Ipcnv to designate the respective rates appropriate to them.

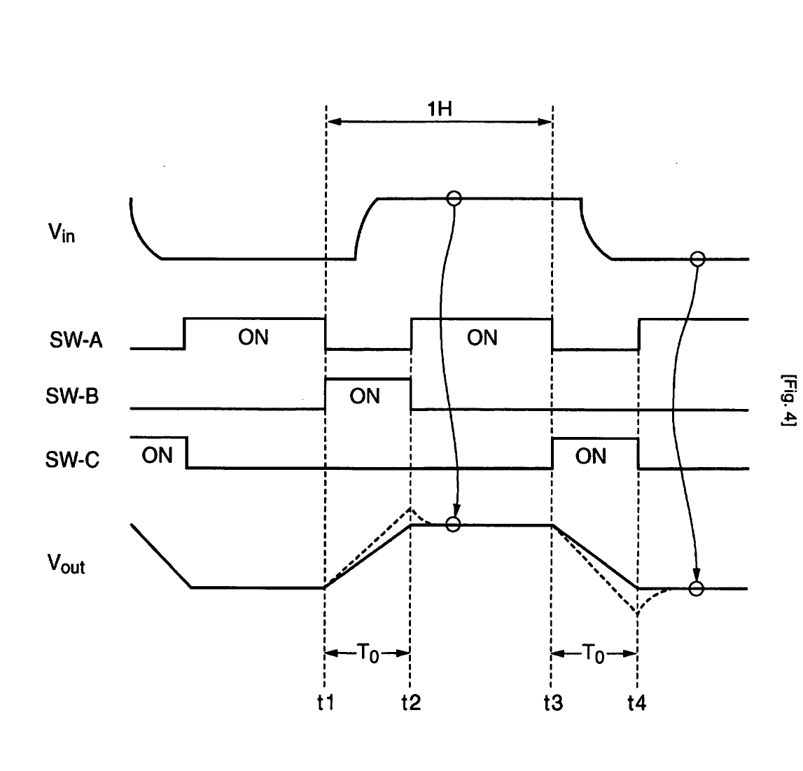

FIG. 4 illustrates the operation in the variable current rate type driving circuit, where with the pre-charge period kept being a constant time period T₀, the current supply rates of the current sources Ipcpv and Ipcnv are set at values required for the output line 40 to reach a target voltage within the constant time period T₀ in accordance with a value of driving signal Vin. Accordingly, as distinct from the case of setting current supply rates at fixed values as shown by the dotted lines in ‘Vout’ in FIG. 4, it is possible to perform control such that the output voltage almost reaches a target voltage every time after the constant time period T₀ has elapsed, even when the pre-charge period is fixed.

The configuration in FIG. 3 is applicable to the case of making both length of period and rate of the pre-charging variable. In other words, the control signals C_{B} and C_{C} for the switches SW-B and SW-C and the rate control signals CI_{B} and CI_{C} may be determined so as to set both of the pre-charging period length and rate at appropriate values in accordance with the value of the driving signal Vin.

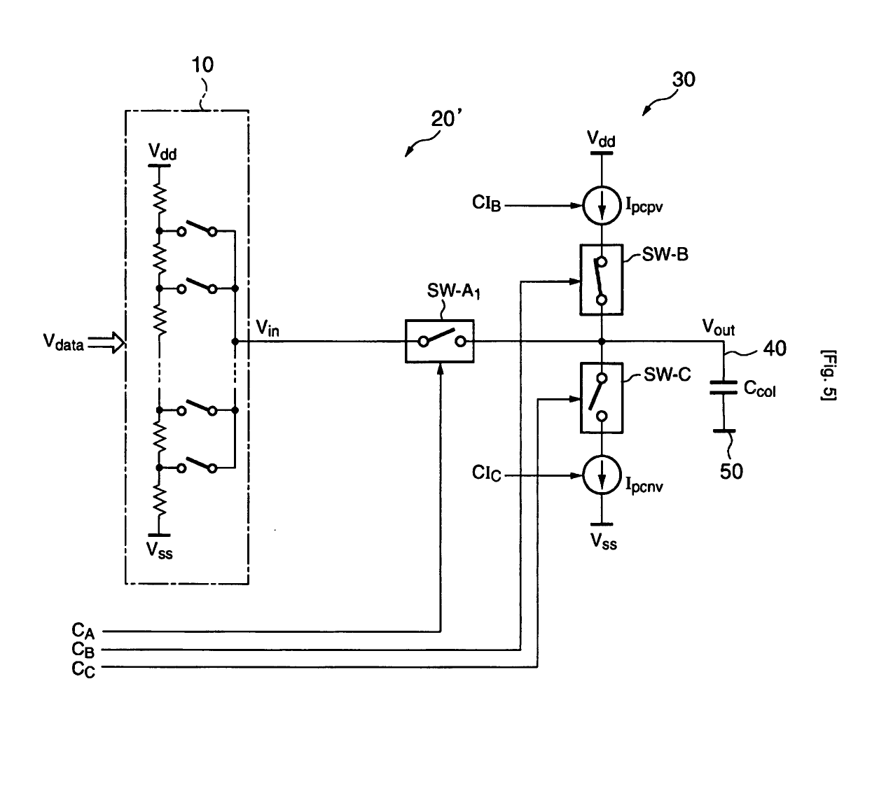

In addition, according to the form for controlling at least one of the pre-charging period length and rate in accordance with the value of the driving signal Vin, since the output voltage has reached the driving voltage already after the charging/discharging operation is finished by means of the current sources, the need for an amplifier to ultimately set the output line at the target voltage is dramatically reduced unlike the conventional case. Therefore, as shown in FIG. 5, it is possible to eliminate the amplifier 21 itself if an applied apparatus or system allows doing so. In this way, the power to be consumed in the amplifier 21 is eliminated completely, thus contributing greatly to power savings in the entire driving circuit.

Next is described how to set the pre-charge period length and rate specifically.

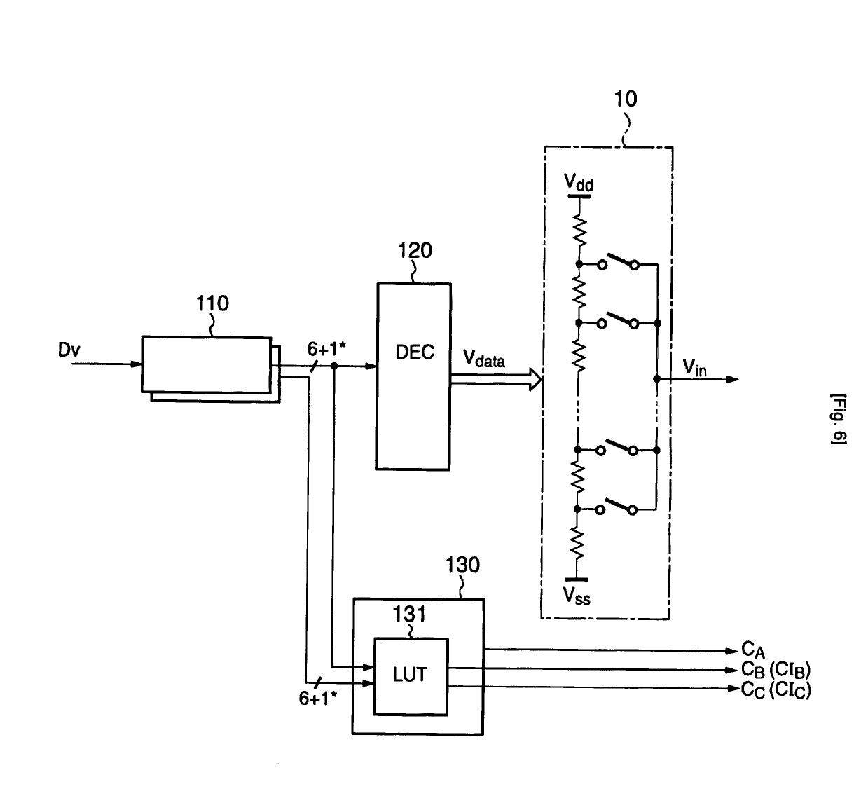

FIG. 6 illustrates a configuration upstream from the driving circuit, which includes a circuit for generating control signals C_{A}, C_{B} and C_{C}.

A digital image signal D_{V} supplied from a signal system, not shown, is once stored in a 2-line memory 110, while an output of readout from the memory 110 is transferred to a decoder 120. The memory 110 is capable of storing the image data corresponding to two horizontal scanning periods. For example, the stored image data indicate an absolute value of a gray-scale level of each pixel in form of six bits per pixel, and further indicate a polarity of the gray-scale level of each pixel using one additional bit.

When the data stored in the memory 110 is transferred to the decoder 120 as current data which are data corresponding to a horizontal scanning period to be presently subjected to displaying, the decoder 120 decodes the transferred data to determine which of the switching elements in the gray-scale voltage generating circuit 10 should be turned ON, and generates the pixel information signal Vdata according to the decoding result. As described earlier, the gray-scale voltage generating circuit 10 switches ON a switch corresponding to the gray-scale level according to the pixel information signal Vdata, and thus supplies the corresponding driving signal Vin to the later stage of circuit.

The output of the memory 110 is also transferred to a control signal generating circuit 130. The control signal generating circuit 130 comprises a Look-Up Table (LUT) memory 131 which receives the previous data, as well as the current data, namely which also receives data of a horizontal scanning period immediately before the horizontal scanning period to be presently subjected to displaying, and generates control signals C_{B} and C_{C} based on the current and last data.

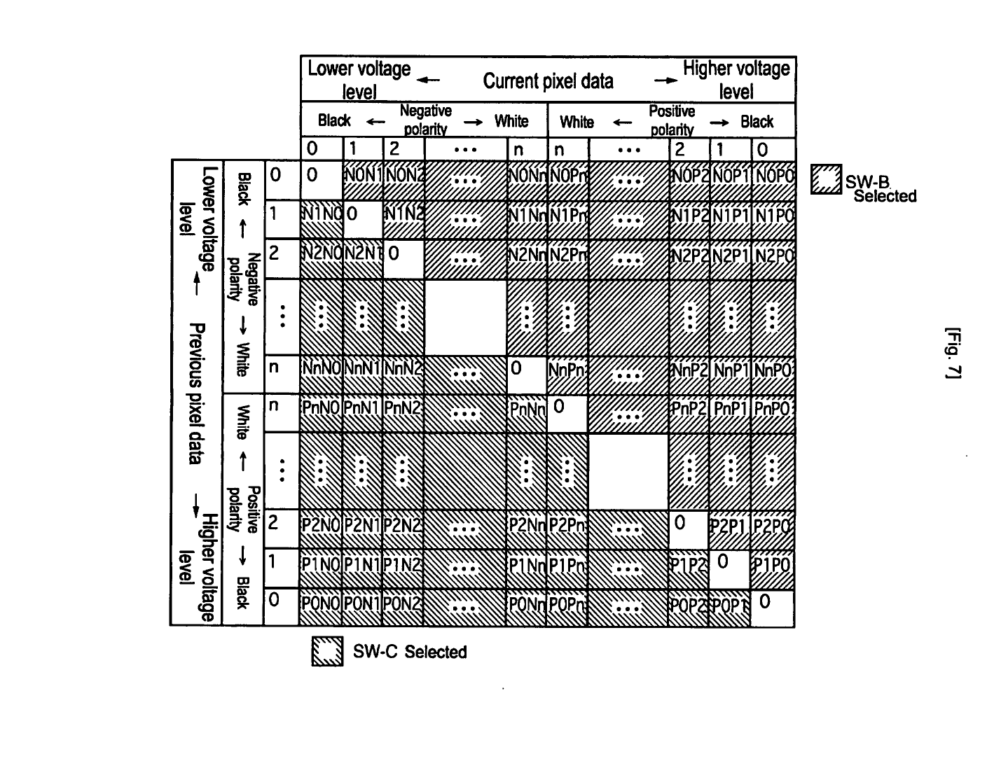

FIG. 7 conceptually illustrates the data stored in the LUT memory 131. In the table in FIG. 7, with high/low in driving voltage level and black/white level, kinds of the previous pixel data are indicated in rows, and kinds of the current pixel data are indicated in columns, and each section where the associated row and column cross each other indicates a value to be currently set for the control signals C_{B} and C_{C}. For example, when the previous pixel data indicates a value of ‘2’ in negative polarity and the current pixel data indicates a value of ‘1’ in positive polarity, a section of ‘N2P1’ stores data indicative of how to set the control signals C_{B} and C_{C}. In the case where the current pixel data is the same as the previous pixel data, values of the control signals C_{B} and C_{C} are not changed, and sections in such cases indicate ‘0’.

The sections of ‘0’ form a diagonal line from the upper left-hand corner to the bottom right-hand corner of the table. Sections above the diagonal line correspond to the cases of selecting the switch SW-B in a horizontal scanning period, while sections under the diagonal line correspond to the case of selecting the switch SW-C in a horizontal scanning period.

As data indicative of the setting on the control signals C_{B} and C_{C} to store, data indicative of a duration length of a pre-charge period is used in an embodiment for varying the pre-charge period, or data indicative of a pre-charge rate is used in an embodiment for varying the pre-charge rate. In addition, in the case of the control based on the charge rate, the LUT memory 131 in the configuration in FIG. 6 outputs the control signals CI_{B} and CI_{C}.

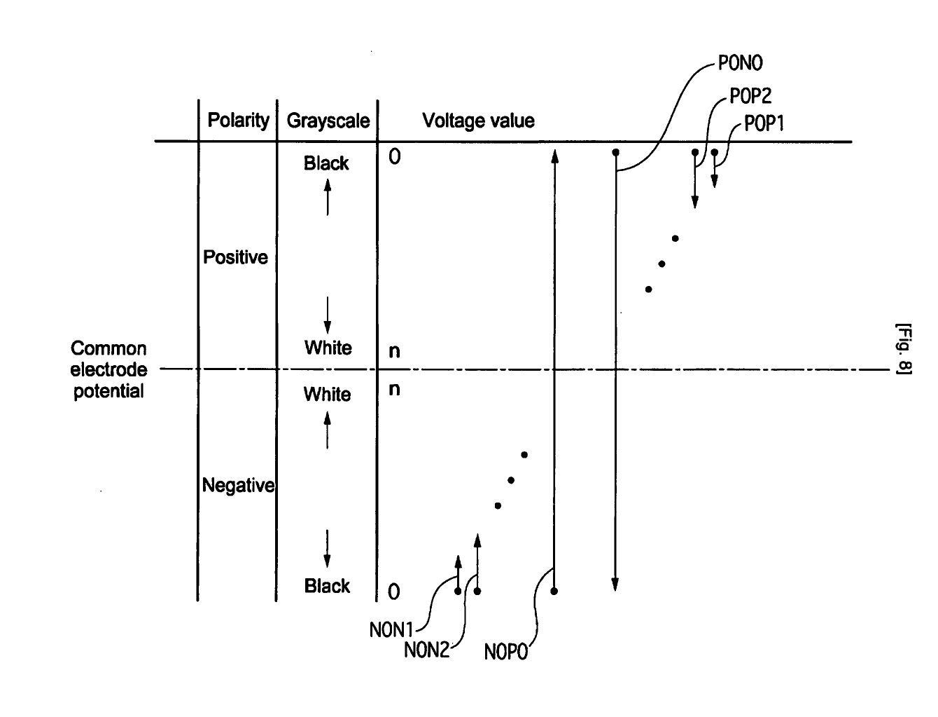

To cite an example, the duration length of a period or the charge rate indicated in a section of ‘N0N2’ is greater than that indicated in a section of ‘N0N1’. This is because the voltage level needs to be varied larger in the case of changing the most black level in a negative polarity to a black level close to white by two steps (N0N2) than in the case of changing the most black level in a negative polarity to a black level close to white by one step (N0N1), as shown in FIG. 8.

In addition, assuming values of duration lengths of pre-charge periods in the sections of N0N1, N0N2, . . . , respectively to be represented as tN0N1, tN0N2, . . . , the following relationship, for example, allows the display image to be provided with the gamma characteristic and allows to adjust a value of difference in each term.
(tP0N0−tP0N1)>(tP0N1−tP0N2)>(tP0N2−tP0N3)> . . .

Similarly, assuming values of pre-charge rates in the sections of N0N1, N0N2, . . . , respectively to be represented as IpN0N1, IpN0N2, . . . , the above relationship can be replaced by the following relationship.
(IpP0N0−IpP0N1)>(IpP0N1−IpP0N2)>(IpP0N2−IpP0N3)> . . .

Accordingly, by defining the control signals C_{B} and C_{C} (or CI_{B} and CI_{C}) so as to indicate thus determined duration length of pre-charge period and/or pre-charge rate, it is possible to achieve the control of appropriate pre-charge of the current sources.

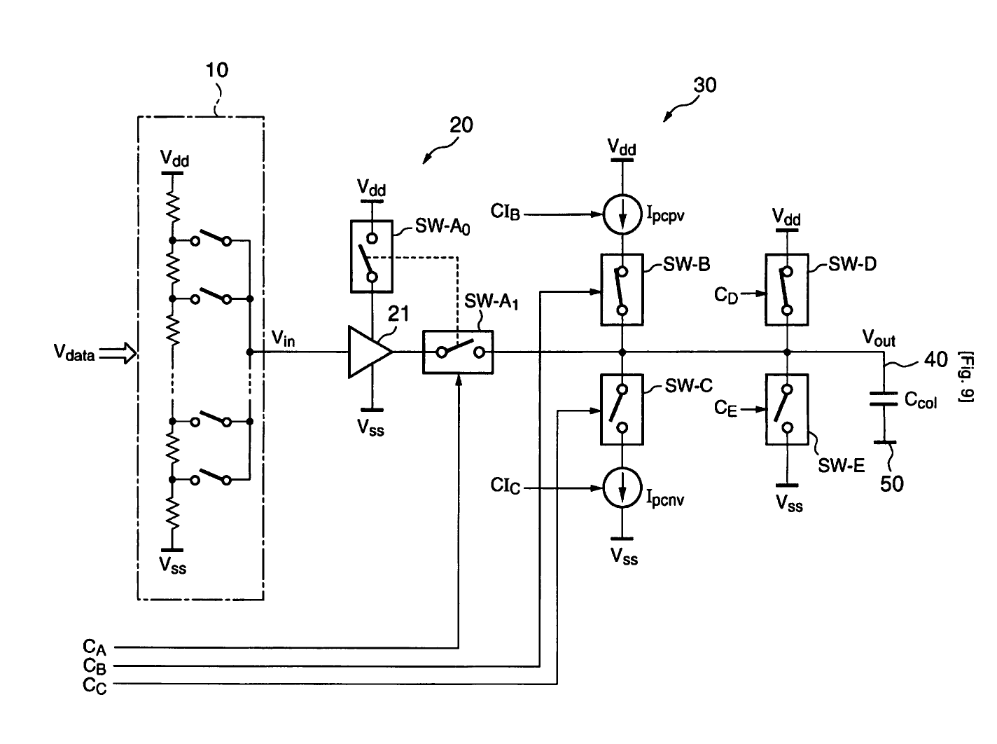

A configuration as illustrated in FIG. 9 may be used as an example of simplifying the control of pre-charge.

In the configuration in FIG. 9, an additional pair of switches are further provided downstream from the output stage 30 in the configuration illustrated in FIG. 3. This pair of switches are composed of a switch SW-D to connect the positive power supply voltage Vdd and output line 40 and a switch SW-E to connect the negative power supply voltage Vss and output line 40.

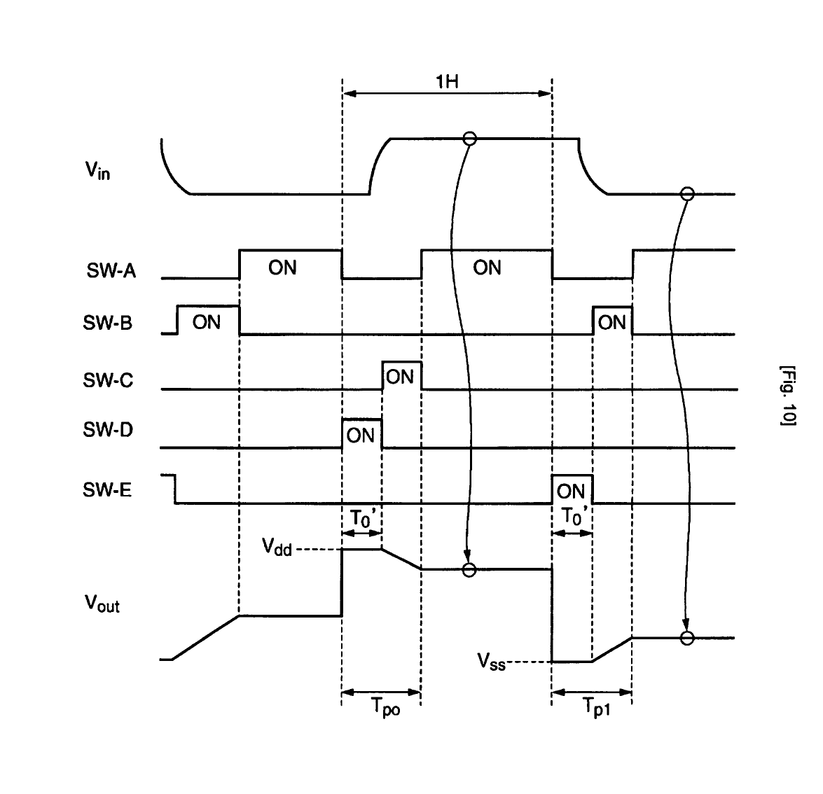

In this configuration, as shown in FIG. 10, in pre-charge time periods TP₀ and TP₁, the switch SW-D is ON first for a predetermined time period T₀ ‘in accordance with the driving signal Vin if it is directed to positive driving, or the switch SW-E is ON first for a predetermined time period T₀’ in accordance with the driving signal Vin if it is directed to negative driving, so that the output voltage is once pulled up to the maximum level Vdd or pulled down to the minimum level Vss of the power supply voltage, respectively. Then, the switch SW-B or SW-C is controlled to be ON in accordance with the driving signal Vin in the horizontal scanning period. As can be seen from FIG. 10, when the switch SW-C is selected, the discharging is carried out by means of the current source Ipcnv, and the voltage is decreased to the target voltage. Meanwhile, when the switch SW-B is selected, the charging is carried out by means of the current source Ipcpv, and the voltage is increased to the target voltage.

In this configuration, the control of pre-charge to the target voltage may be based on the duration length of a pre-charge period using the control signals C_{B} and C_{C}, or may be based on the pre-charge rate using the control signals CI_{B} and CI_{C}.

In this way, since the value of the duration length or rate of the pre-charging can be determined using only the current data with reference to the fixed values Vdd and Vss, it is not necessary to refer to the previous data as described above for determining the length or rate and it is thereby possible to simplify the configuration.

The embodiment shown in FIGS. 9 and 10 is intended to compare the present value of the driving signal Vin with a reference value to define a duration length or rate of pre-charge, where the positive and negative maximum possible values are set as the reference value. If the former is larger than the latter, pre-charging is performed such that the output voltage Vout is increased as in the period Tp₁. If the former is smaller than the latter, pre-charging is performed such that the output Vout is reduced as in the period Tp₀. Thus, such comparison of the present value can lead to definition of charging mode.

The following is another modification to define charging mode based on comparison.

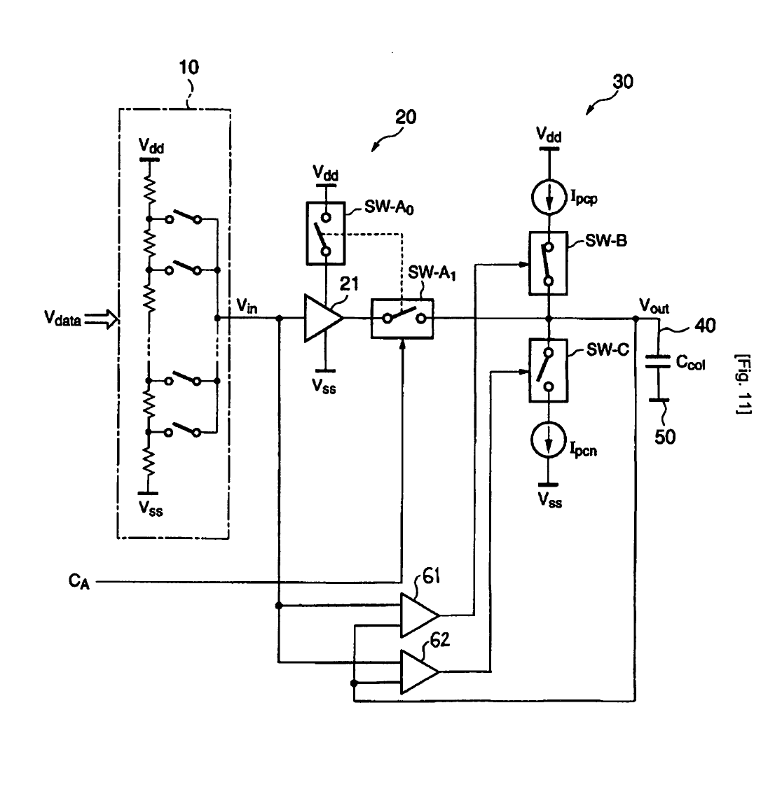

FIG. 11 shows a general configuration of a driving circuit according to the modification.

In FIG. 11, there are provided comparators 61 and 62 that receive the driving signal Vin at their first inputs, respectively and receive the output voltage Vout at their second inputs, respectively. A comparison output of the comparator 61 becomes a control signal for the switch SW-B, and a comparison output of the comparator 62 becomes a control signal for the switch SW-C.

The comparator 61 compares the voltage value of the driving signal Vin with a value of the output value Vout, and generates an output of a high level for turning on the switch SW-B only when the voltage value of the driving signal Vin is greater than it. The comparator 62 compares the voltage value of the driving signal Vin with a value of the output value Vout, and generates an output of a high level for turning on the switch SW-C only when the voltage value of the driving signal Vin is smaller than it.

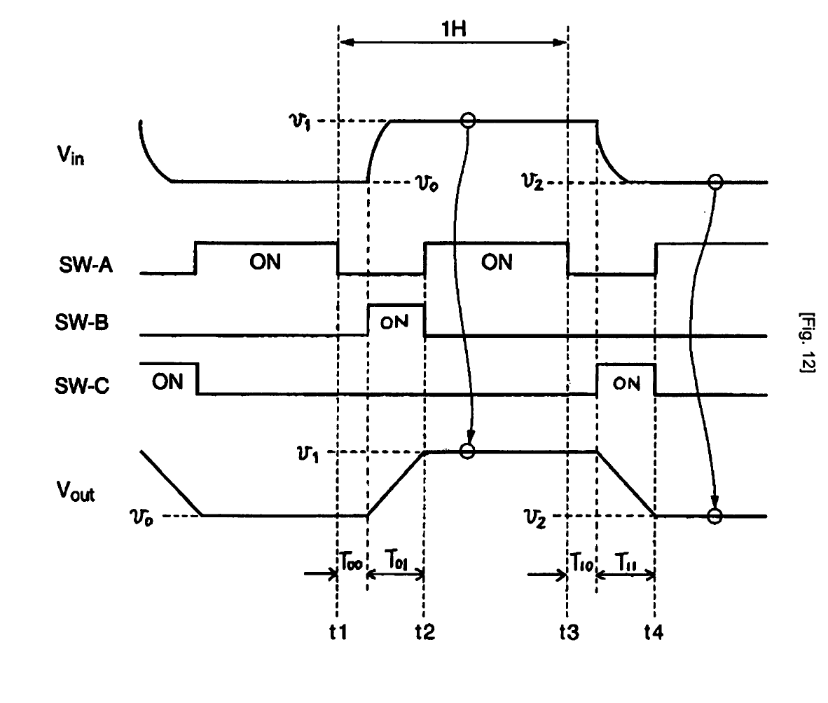

FIG. 12 is a time chart representing the operation of this driving circuit, wherein the driving signal Vin makes its voltage changes of v₀, v₁, v₂ each time the horizontal scanning period is changed, as an example.

At first, regarding a horizontal scanning period of a time t1 to a time t3, the comparator 61 compares the drive signal Vin with the output voltage Vout, in which its comparison output is held at a low level during a preceding period T₀₀ because the driving signal Vin as well as the output voltage Vout remains having a voltage value v₀. During the subsequent period T₀₁, however, the comparator 61 makes a comparison output of a high level because the driving signal Vin is switched to a higher voltage value v₁ than the voltage value v₀. Thereby, the high level output of the comparator 61 causes the switch SW-B to be turned on, so that the current from the current source Ipcp is provided to the output line 40 through the switch SW-B. Accordingly, the value of the output voltage Vout is gradually increased as shown in the Figure, but when the voltage value v₁ of the driving signal Vin is not determined to be greater than the value of the output voltage Vout, or equivalently, when the value of the output voltage Vout is equal to or greater than the value of the driving signal Vin (time t2), the comparator 61 can not make a high level comparison output any more to change its comparison output to a low level. In response to this, the switch SW-B is turned off and the switches SW-A₀, SW-A₁ are turned on. Therefore, the output voltage Vout stops rising, and the output voltage Vout is held at the voltage value v1 of the driving signal Vin on the output line 40 on the basis of the operation of the amplifier 21 until the driving signal Vin is updated in the next horizontal scanning period.

In horizontal scanning periods from the time t3, the comparator 62 compares the driving signal Vin with the output voltage Vout, and holds its comparison output at a low level during the preceding period T₁₀ because the driving signal Vin as well as the output voltage Vout has still the voltage value v₁. During the subsequent period T₁₁, however, the comparator 62 makes a comparison output of a high level because the driving signal Vin is switched to a lower voltage value v₂ than the voltage value v₁. Thereby, the high level output of the comparator 62 causes the switch SW-C to be turned on, so that the negative current from the current source Ipcn is provided on the output line 40 through the switch SW-C. Accordingly, the value of the output voltage Vout is gradually decreased as shown in the Figure, but when the voltage value v₂ of the driving signal Vin is not determined to be smaller than the value of the output voltage Vout, namely, when the value of the output voltage Vout is equal to or smaller than the value of the driving signal Vin (time t4), the comparator 61 can not make a high level comparison output any more to change a comparison output to a low level. In response to this, the switch SW-C is turned off and the switches SW-A₀, SW-A₁ are turned on. Therefore, the output voltage Vout stops falling, and the output voltage Vout is held at the voltage value v2 of the driving signal Vin on the output line 40 on the basis of the operation of the amplifier 21 until the driving signal Vin is updated in the next horizontal scanning period.

In this way, comparison of the present value (Vin) and previous value (Vout) of the driving signal is performed, and when the former is greater than the latter, pre-charging is made such that the output voltage Vout is increased as in the period T₀₁, on one hand, or when the former is smaller than the latter, pre-charging is made such that the output voltage Vout is decreased as in the period T₁₁, on the other hand. By so doing, it is possible to define the charging mode with a pre-charge duration necessary to cause the output voltage Vout to be the present value without relying on such means as the memory 131 mentioned above. This modification also has an advantage in that a length of a charging/discharging period T₀₀, T₁₁ can be automatically obtained by the comparison of the present and previous values each time.

Although the modification of FIG. 11 is intended to define the pre-charge mode of the current sources based on a comparison result between the present value and the previous value, a pre-charge mode of alternative voltage sources may be defined based on the comparison result.

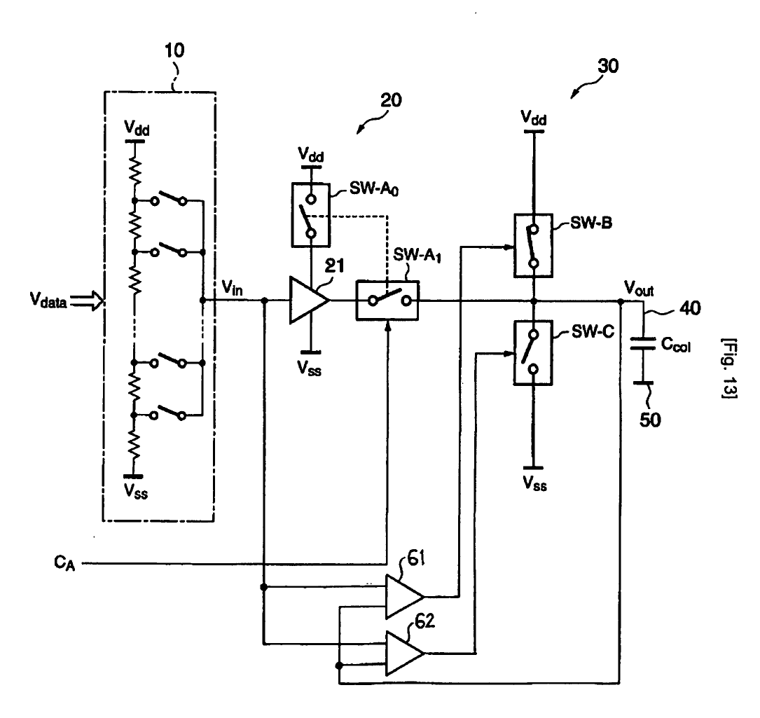

FIG. 13 shows a configuration of causing a pair of voltage sources to pre-charge the output line 40. Difference from FIG. 11 is that the switch SW-B makes switching of connection between a positive constant voltage Vdd and the output line 40 and the switch SW-C makes switching of connection between a negative constant voltage Vss and the output line 40.

Also according to this, the comparators 61 and 62 turn on the switches SW-B, SW-C so as to perform a necessary charging/discharging operation for a necessary length of duration for the output line 40 to the extent that the output value (Vout) of the driving signal reaches the present value (Vin). However, such a charging/discharging operation relies on the constant voltage sources, so that change of the output voltage Vout shown in a period corresponding to the period T₀₁, T₁₁ of FIG. 12 follows a curve mainly determined by a time constant of the charging/discharging circuit formed.

As can be seen in the above mentions, the on-timing of the switch SW-A₀, SW-A₁ may be implemented by a circuit that causes the control signal C_{A} to be active in response to the off-operation of the switch SW-B, SW-C. On the other hand, the off-timing of the switch SW-A₀, SW-A₁ may be defined based on a horizontal synchronizing signal of the driving signal Vin, for example.

The above description is based on the premise that a liquid crystal display panel to be used is arbitrarily chosen, and so of course the present invention can be applied to the so-called LTPS (low temperature poly-silicon) type liquid crystal display panels in which display driving circuitry is formed on a glass substrate identical with the liquid crystal supporting substrate.

It should be noted that the above-mentioned embodiments are confined to forms for supplying a gray-scale voltage as a target voltage to a liquid crystal display device, but the present invention is not necessarily limited to such forms.

Some representative embodiments of the present invention have been described above, but those skilled in the art can modify these embodiments if desired to several variants with out departing from the spirit of an invention defined in claims.

### INDUSTRIAL APPLICABILITY

The present invention is applicable to a driving circuit for supplying a target voltage signal to a capacitive load and to an apparatus using such a driving circuit.

1. A driving circuit for driving a capacitive load of a display device, comprising:
driving signal supplying means for supplying a driving signal having a target voltage to be applied;
an amplifying stage for receiving the driving signal and selectively outputting the driving signal to the capacitive load; and
a pair of current sources for selectively supplying a positive current and a negative current to the capacitive load, respectively during their on-states,
the driving circuit repeating a repetitive operation including a pre-operation where any one of the current sources is switched ON in accordance with the driving signal and then switched OFF and a post-operation where the amplifying stage is switched to a state for outputting the driving signal to the capacitive load after the pre-operation.

2. A driving circuit according to claim 1, wherein a duration length of an ON period of the relevant current source and/or a current supply rate of the relevant current source during the pre-operation is made variable in accordance with a value of the driving signal in a repetition period of the repetitive operation.

3. A driving circuit according to claim 1, wherein a duration length of an ON period of the relevant current source and/or a current supply rate of the relevant current source during the pre-operation is made variable in accordance with a value of the driving signal in a repetition period of the repetitive operation and a value of the driving signal in another repetition period previous to said repetition period.

4. A driving circuit for driving a capacitive load of a display device, comprising:
driving signal supplying means for supplying a driving signal having a target voltage to be applied;
an amplifying stage for receiving the driving signal and selectively outputting the driving signal to the capacitive load;
a pair of power sources for selectively performing charging and discharging to the capacitive load, respectively; and
comparing means having one input receiving a voltage value of the driving signal and the other input receiving a voltage value on an output line coupled to the capacitive load,
the driving circuit repeating a repetitive operation including a pre-operation where charging or discharging is performed by any one of the power sources and then stopped and a post-operation where the amplifying stage is switched to a state for outputting the driving signal to the capacitive load after the pre-operation,
the charging and discharging operation performed by the pair of the power sources being controlled based on a comparison output of the comparing means during the pre-operation.

5. A driving circuit as defined in claim 4, wherein a discharging operation is performed if the comparison output indicates that the voltage value on the output line is greater than the voltage value of the driving signal, an a charging operation is performed if the comparison output indicates that the voltage value on the output line is smaller than the voltage value of the driving signal.

6. A driving circuit as defined in claim 5, wherein one of the charging and discharging operations is continued until the comparison output indicates that the voltage value on the output line reaches the voltage value of the driving signal.

7. A driving circuit according to claim 1, wherein the target voltage is a gray-scale voltage.

8. A driving circuit according to claim 1, wherein the capacitive load is a liquid crystal cell.

9. A driving circuit according to claim 1, wherein the driving signal supplying means includes analog to digital converting means.

10. A display device using a driving circuit according to claim 1.
